(19) United States
(12) Patent Application Publication
(10) Pub. No.: US 2012/0217681 A1
(43) Pub. Date: Aug. 30, 2012

(54) PROCESS FOR PRODUCING NANOFIBRES

(75) Inventors: Roman Zieba, Heddesheim (DE); Felix Major, Mannheim (DE); Evgueni Klimov, Ludwigshafen (DE); Alexander Traut, Schriesheim (DE); Laurence Pottie, Mannheim (DE); Bernd Smarsly, Pohlheim (DE); Rainer Ostermann, Hemer (DE)

(73) Assignee: BASF SE, Ludwigshafen (DE)

(21) Appl. No.: 13/508,268

(22) PCT Filed: Oct. 26, 2010
(86) PCT No.: PCT/EP10/66173

§ 371 Date: May 4, 2012

(30) Foreign Application Priority Data
Nov. 4, 2009 (EP) 09175023.2

(51) Int. Cl. B29C 47/00

(52) U.S. Cl. 264/465

(57) ABSTRACT

The present invention relates to a process for producing metal oxide nanofibers using a sol-gel precursor. The nanofibers produced by the process according to the invention are notable for an increased metal oxide content compared to the prior art.

The present invention relates to a process for producing metal oxide nanofibers using a sol-gel precursor. The “green fibers” produced by the process according to the invention, consisting of a polymer component and an inorganic content, with or without solvent residues, are notable for an increased inorganic content compared to the prior art. In the process according to the invention, calcination, the thermal removal of the polymer component and transformation of the inorganic content to the desired metal oxide produce the inventive metal oxide nanofibers.

Nanofibers are gaining increasing significance, for example as filtration and separation media, in textile production, optics, electronics, biotechnology, pharmacy, medicine and plastics technology. The term “nanofibers” refers to fiber structures whose diameter is within a range from about 0.1 to 999 nm (also referred to as nanoscale). The term further relates to nanostructures such as nanowires and nanotubes, both of which have a nanoscale cross section.

The currently customary process for producing nanofibers is known as electrospinning. This involves bringing a polymer solution or a polymer melt which comprises a metal compound, for example a metal salt, and if appropriate further additives into a strong electrical field by means of two electrodes. Electrostatic charge gives rise to local instabilities in the solution, which are shaped first to conical structures and subsequently to fibers. While the fibers move in the direction of an electrode, the majority of the solvent evaporates and the fibers are additionally stretched. In the course of the subsequent calcination of the fibers, the metal compound is transformed to the corresponding metal oxide. In this way, oxidic nanofibers with a diameter of <1 μm are obtained. The use of such fibers is of industrial interest, for example, in filtration applications, as a constituent of gas sensors and in catalyst applications.

The production of nanofibers, especially of ZnO nanofibers, is described, for example, by Siddheswaran et al. (“preparation and characterisation of ZnO nanofibers by electrospinning”, Cryst. Rest. Technol. 2006, 41, 447-449). Siddheswaran et al. first prepare a precursor solution consisting of polyvinyl alcohol, zinc acetate and water, which is transformed to a viscous gel at elevated temperature. Subsequently, this precursor solution is spun to nanofibers with a syringe-based electrospinning unit (“needle electrospinning”). These nanofibers are subsequently calcined to ZnO fibers. The ZnO nanofibers produced by this process have a very inhomogeneous surface structure and varying diameter, and are fused to one another at the contact sites, which additionally results in a low aspect ratio.

A process for producing SnO₂ nanofibers is described by Zhang et al. (“fabrication and ethanol-sensing properties of micro gas sensor based on electrospun SnO₂-nanofibers”, Sensors and Actuators B 2008, 67-73). Zhang at al. prepare a precursor solution consisting of polyvinyl alcohol, tin(IV) chloride and water, and spin it with an electrospinning unit to give nanofibers. These nanofibers are subsequently calcined to give SnO₂ nanofibers. The SnO₂ nanofibers produced with the aid of this process have varying diameters and are likewise fused to one another at the contact sites, which results in a low aspect ratio and additionally in unsatisfactory metal loading.

It is an object of the present invention to provide an improved process for producing metal oxide nanofibers with a diameter in the range from 0.1 to 999 nm. It is a further object of the invention to provide a process for producing metal oxide fibers, with the aid of which it is first possible to obtain green fibers with a high inorganic content, which are subsequently calcined.

This object is achieved by a process for producing metal oxide fibers with a diameter in the range from 0.1 to 999 nm, comprising the steps of:

(a) providing a solution of one or more metal compounds in at least one solvent selected from the group of water, ethanol, methanol, isopropanol, n-propanol, tetrahydrofuran and dimethylformamide,
(b) alkaline precipitation of the at least one metal present in the metal compound in the form of the hydroxide thereof from the solution provided in (a) in order to obtain a suspension,
(c) removing the at least one hydroxide precipitated in process step (b),
(d) redispersing or dissolving the at least one hydroxide removed in process step (c) in an amine or solvent-amine mixture in order to obtain a sol-gel precursor,
(e) preparing a solution comprising one or more polymer(s), one or more solvents, and the sol-gel precursor obtained in process step (d),

(f) electrospinning the solution prepared in process step (e) and

(g) removing the polymer.

It is found that, with the aid of the above-described process, it is possible to obtain metal oxide fibers with a diameter in the nanometer range. The “green fibers” produced in process step (f) have an increased inorganic content compared to green fibers known from the prior art. The solution which is prepared for the electrospinning step has a high hydrolytic stability—it is storable under air over a period of about 12 months. This is particularly advantageous because the loss of mass when the polymer is removed in process step (g), for example in the calcination, is thus lower. In addition, the fibers obtained in process step (g) have a lower porosity and roughness. This effect is enhanced by the fact that the inorganic component is already present in the form of the (crosslinked) metal hydroxide after process step (f) and hence is very similar to the metal oxide form desired as early as at this point in the process. The use of the specific precursor solution of the metal hydroxide, prepared in process steps (b), (c) and (e), enables production of green fibers with the correspondingly high metal contents.

In the preparation of the solution of one or more metal compounds in process step (a), a metal compound is, or a plurality of metal compounds are, dissolved in a solvent selected from the group of water, ethanol, isopropanol, n-propanol, tetrahydrofuran (THF) and dimethylformamide, or in a mixture of two, three or more of the aforementioned solvents. The amount of the metal compound which is dissolved in the solvent may vary over wide ranges. In general, the metal ion present in the metal compound has, or the metal ions have, a concentration in the solution in the range from 0.1 to 7 mol/l, preferably in the range from 0.2 to 1 mol/l. The term “metal compound” in the context of the present invention means a compound in which the metal is bonded anionically or covalently to organic or inorganic ligands. The at least one metal compound is, for example, inorganic or organic compounds or salts of one or more metal(s) selected from the group of Cu, Ag, Au, Ti, Zr, Hf, V, Nb, Ta, Cr, Mo, W, Mn, Re, Fe, Ru, Ni, Pd, Co, Rh, Ir, Sb, Sn, In, Al, Ga, Er and Zn. In a preferred embodiment of the invention, the metal of the metal compound is selected from the group of Sb, Sn, In, Al, Ga and Zn. In a particularly preferred embodiment, the mixture comprises compounds of the metals Sn, Sb or In, or the mixture comprises compounds of the metals Sn and Sb.

Inorganic compounds in the context of the present invention are, for example, chlorides, sulfates and nitrates, if these combinations of organic anions and the particular metal cations exist. Organic compounds in the context of the present invention are salts of carboxylic acids, for example formates, acetates, citrates and acetylacetonates with the corresponding metals, if combinations of organic anions and the particular metal cation exist.

After the provision of the solution of the one or more metal compounds in process step (a) or the preparation thereof, an alkaline precipitation of the at least one metal ion in the form of the hydroxide thereof is undertaken in process step (b). In process step (b), the alkaline precipitation of the at least one metal or metal ion is effected by addition of at least one ammonium compound and/or of at least one alkali metal hydroxide. The compounds which can be used for alkaline precipitation are generally selected from the group of NR₄OH where R is independently H or C₁ to C₄-alkyl, NH₄OH, NH₃, NaOH, KOH, NH₄HCO₃ and (NH₄)₂CO₃, NH₄F, NaF, KF and LiF, or a mixture of two, three or more of the aforementioned compounds. The addition of the ammonium compounds and/or of the alkali metal hydroxide in process step (b) adjusts the pH of the solution provided in process step (a) to a pH in the range from 8 to 12, preferably in the range from 9 to 10. The amount of the ammonium compound or of the alkali metal hydroxide needed to perform the alkaline precipitation may vary over wide ranges. The person skilled in the art uses an appropriate amount such that the pH is established within the above-specified range and the metal ions precipitate out of the solution in the form of hydroxides thereof.

In a preferred embodiment of the invention, performance of the alkaline precipitation in process step (b) is preceded by addition to the solution of at least one stabilizer selected from the group of the amino acids, such as alanine, phenylalanine, valine, leucine, and ε-caprolactam. The proportion of this stabilizer can be varied over wider ranges and is generally 0.5 to 10% by weight, preferably 1 to 5% by weight, based on the solution provided in process step (a).

In a further preferred embodiment of the invention, the suspension obtained after the alkaline precipitation in process step (b) is treated at a temperature in the range from 60 to 200° C., preferably at a temperature in the range from 100 to 160° C., over a period of 1 hour to 24 hours, preferably over a period in the range from 2 to 6 hours, and at a pressure in the range from 1 to 2 bar abs. This leads to a suspension of metal oxide precursors in crystalline form. This suspension can likewise be added to a mixture prepared in process step (e) in a proportion of 1 to 99% by weight. In a further preferred embodiment of the invention, this intermediate step, the preparation of the dispersion of metal oxide precursors, is performed in the presence of a stabilizer selected from the group of alanine, phenylalanine, valine, leucine and ε-caprolactam.

Performance of the alkaline precipitation in process step (b) is followed by the removal of the precipitated hydroxides in the subsequent process step (c). The hydroxides are removed from the mother liquor by means of filtration, decantation and/or centrifugation. Processes for removing a precipitated solid from a mother liquor are known to those skilled in the art and are not explained in detail at this point.

In a preferred embodiment of the invention, the metal hydroxides removed in process step (c) are, or the metal hydroxide removed in process step (c) is, washed. For washing, a solvent selected from the group of water, methanol, ethanol, i-propanol and n-propanol or a mixture thereof is generally used. This removes, for example, ammonium ions, alkali metal ions and chloride ions from the metal hydroxide. For complete removal of possible disruptive components in the metal hydroxide, the washing operation can be repeated more than once. In a preferred embodiment, the solvent or the solvent mixture which is used for washing has a pH which corresponds to the pH at which the alkaline precipitation has been undertaken in process step (b).

After the removal of the metal hydroxide or of the metal hydroxides in process step (c), or after the optional washing step, the precipitate or the metal hydroxide is dissolved in an amine, or preferably in a solvent-amine mixture. In a preferred embodiment of the invention, the solvent in the solvent-amine mixture is selected from the group of water, methanol, ethanol, i-propanol, n-propanol, tetrahydrofuran (THF) and dimethylformamide, or a mixture thereof; the solvent is more preferably water. The amine present in the solvent-amine mixture is generally a primary, secondary or tertiary amine of the general formula NR₃ where R is independently H, a substituted or unsubstituted, straight-chain or branched alkyl group having 1 to 6, preferably 2 to 4 and more preferably 2 carbon atoms.

“Alkyl group” means a saturated aliphatic hydrocarbon group which may be straight-chain or branched and may have from 1 to 6 carbon atoms in the chain. “Branched” means that a lower alkyl group such as methyl, ethyl or propyl is joined to a linear alkyl chain. The alkyl group is, for example, methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl and 3-methyl-1-pentyl. Particular preference is given to ethyl and propyl.

In a particularly preferred embodiment of the invention, the amine is diethylamine.

The weight ratio of solvent to amine can be varied over wide ranges and is generally in the range from 5 to 10:1 to 5, preferably in the range from 7 to 8:3 to 2. The concentration of the metal hydroxide or of the metal hydroxides is generally in the range from 5 to 30% by weight, preferably in the range from 10 to 20% by weight; the proportion is more preferably 15% by weight, based on the total mass of the solution or dispersion prepared in process step (d).

The mixture prepared in process step (d), also referred to as sol-gel precursor, is miscible with customary solvents used in the production of metal oxide nanofibers over both concentration ranges. In addition, the presence of a plurality of hydroxides in the precursor leads to good mixing of the hydroxides, which leads to a very homogeneous metal distribution in the nanofibers produced subsequently. The use of the so-called sol-gel precursor in the process according to the invention is advantageous, since the electrospinning provides nearly always the same amounts of green fibers.

In process step (e), a solution comprising one or more polymers, one or more solvents and the mixture prepared in process step (d), the sol-gel precursor, is prepared, from which the metal oxide nanofibers are subsequently produced. In general, in process step (e), the solvent or solvent mixture is selected such that both the one or more polymer(s) and the sol-gel precursor are soluble therein. “Soluble” is understood to mean that the polymer and the sol-gel precursor each have a solubility of at least 1% by weight in the corresponding solvent or solvent mixture. The person skilled in the art is aware that it is necessary for this purpose to balance the polarities of the polymer, of the sol-gel precursor and of the solvent with respect to one another. This can be done with the aid of general technical knowledge.

In general, the solvent used in process step (e) is selected from the group of water, methanol, ethanol, ethanediol, n-propanol, 2-propanol, n-butanol, isobutanol, tert-butanol, cyclohexanol, formic acid, acetic acid, trifluoroacetic acid, diethylamine, diisopropylamine, phenylethylamine, acetone, acetylacetone, acetonitrile, diethylene glycol, formamide, dimethylformamide (DMF), dimethyl sulfoxide (DMSO), toluene, dimethylacetamide, N-methylpyrrolidone (NMP) and tetrahydrofuran or is a mixture of two or more of the afore-mentioned solvents. The solvent which is used to prepare the solution in process step (e) is preferably one or more selected from water, methanol, ethanol, ethanediol and isopropanol.

The polymer which is used in the preparation of the solution in process step (e) is generally selected from the group of polyethers, polyethylene oxides, polyvinyl alcohols, polyvinyl acetates, polyvinylpyrrolidones, polyacrylic acids, polyurethanes, polylactides, polyglycosides, polyvinylformamides, polyvinylamines, polyvinylimines and polyacrylonitriles, or is mixtures of two or more of the aforementioned polymers. Preferred polymers have been found to be polyvinyl alcohols, polyvinyl acetates, polyvinylpyrrolidones. Copolymers of the aforementioned polymers have also been found to be suitable, such as polyvinyl alcohol-polyvinyl acetate copolymers or mixtures of copolymers.

In general, the one polymer or the plurality of polymers in the context of the present invention comprise polymeric material degradable thermally, chemically, radiatively, physically, biologically with plasma, ultrasound, or by extraction with a solvent. The proportion of the polymer in the solution prepared in process step (e) may vary over relatively wide ranges. In general, the proportion of the polymer is in the range from 1 to 20% by weight, preferably in the range from 5 to 15% by weight and more preferably in the range from 6 to 10% by weight, based on the solution prepared in process step (e).

The proportion of the sol-gel precursor, based on the solution prepared in process step (e), is generally in the range from 1 to 20% by weight, preferably in the range from 5 to 10% by weight and more preferably in the range from 6 to 10% by weight.

The remaining constituent of the solution prepared in process step (e) is formed by the solvent or by the solvent and any further additives present.

In one embodiment of the invention, crystalline and/or amorphous metal oxide nanoparticles which typically have a mean particle size in the range from 1 to 100 nm are added to the solution prepared in process step (e). The proportion of the particles added is in the range from 1 to 99% by weight, preferably in the range from 1 to 40% by weight, more preferably in the range from 1 to 20% by weight, based on the solution or suspension prepared in process step (e). In a preferred embodiment, the crystalline metal oxide nanoparticles are ATO particles (antimony-doped tin oxide particles) and/or ITO particles (tin-doped indium oxide particles).

In one embodiment of the invention, crystalline and/or amorphous metal nanoparticles which typically have a mean particle size in the range from 1 to 100 nm are added to the solution prepared in process step (e). The proportion of the particles added is in the range from 1 to 99% by weight, based on the solution prepared in process step (e). In a preferred embodiment, the nanoparticles are particles of silver, gold, copper or aluminum.

The nanofibers—consisting of one or more polymer(s), one or more metal oxide precursors—are produced from the solution prepared in process step (e) by means of electrospinning out of this solution. Electrospinning processes are known to those skilled in the art. The electrospinning can be effected, for example, with an electrospinning unit, the construction of which is identical or similar to the electrospinning units described in the literature (Xia et al., Advanced Materials 2004, 16, 1151). The electrospinning can also be effected with an electrospinning unit described, for example, in WO 2006/131081 A1 or in WO 2007/137530 A2.

The removal of the polymer or of the polymers in process step (g) of the process according to the invention is generally accomplished thermally, chemically, radiatively, physically, biologically with plasma, ultrasound, or by extraction with a solvent. The removal of the polymer is preferably accomplished thermally by means of calcination. The calcination is effected generally over a period of 1 to 24 hours, preferably over a period of 3 to 6 hours, at a temperature in the range from 250 to 900° C., preferably at a temperature in the range from 300 to 800° C., more preferably at a temperature in the range from 400 to 700° C. The atmosphere may generally be an air atmosphere, but also a nitrogen atmosphere which may additionally comprise oxygen or hydrogen. In a preferred embodiment of the invention, the calcination is performed in an atmosphere of approx. 78% by volume of nitrogen, 21% by volume of oxygen, or in pure nitrogen or in a mixture of nitrogen with hydrogen (1 to 4% by volume) or in a mixture of nitrogen with oxygen (>21% by volume). The metal oxide fibers obtained after the calcination have a diameter in the range from 0.1 nm to 999 nm, preferably in the range from 10 nm to 300 nm, preferably in the range from 50 nm to 200 nm. The aspect ratio is in the range from 10 to 1000, preferably in the range from 100 to 500.

In a preferred embodiment of the invention, the nanofibers are dried after the electrospinning and before the calcining. The nanofibers are dried typically at a temperature in the range from 80 to 180° C., preferably at a temperature in the range from 100 to 150° C., in ambient atmosphere, under air or under reduced pressure.

In a further embodiment of the invention, a process for producing metal fibers is provided, in which the metal oxide fibers produced in process step (g) are reduced to the corresponding metal fibers. It is common knowledge to the person skilled in the art how metal oxides can be reduced to the corresponding metals. Suitable reducing agents are hydrogen, carbon monoxide, gaseous hydrocarbons, carbon, and also metals which are less noble, i.e. have a more negative standard potential than the metal to be reduced, and additionally sodium borohydride, lithium aluminum hydride, alcohols and aldehydes. In a further embodiment of the invention, the metal oxide fibers can be reduced or partly reduced electrochemically. The person skilled in the art can employ these reduction methods with the aid of general technical knowledge and thus obtains the corresponding metal fibers with a diameter of <1 μm.

The nanofibers can also be used for electrochemical deposition of metal oxides and metals.

The nanofibers obtained have a multitude of interesting magnetic, electrical and catalytic properties, which make them very useful for the practical application thereof.

They are therefore promising new materials for different components in microelectronics and optoelectronics. There are also various possibilities for application in catalysis or filtration. The invention therefore further provides for the use of the inventive metal oxide fibers as additives for polymers, for mechanical reinforcement, for antistatic/electrically conductive modification, for flame retardancy, for improvement of thermal conductivity of polymers; and as constituents of filters and filter parts for gas and liquid filtration, particularly for high-temperature filtration, as a constituent of a catalyst; as a constituent of lithium ion batteries, solar cells, fuel cells and other electronic components/elements.

The invention is illustrated in detail by examples which follow:

### EXAMPLE 1

### Synthesis of ATO (Antimony Tin Oxide) Nanofibers

The sol-gel precursor solution comprising 6.7% by weight of PVP (Kollidon 92F from BASF SE), 6.7% by weight of ATO precursor, 26.4% by weight of water, 48.9% by weight of ethanol and 11.3% by weight of diethylamine was prepared as follows:

200 g of a 25% by weight aqueous ammonium hydroxide solution were introduced into a glass flask. While stirring vigorously, a solution of 78.4 g of tin(IV) chloride and 5.2 g of antimony(III) chloride in 960 g of ethanol and 16 g of concentrated HCl was added. The precipitate formed was removed by means of a centrifuge and washed four times with water with a pH of 10 (set with ammonia solution), being redispersed with an Ultraturrax each time. The precipitate obtained was dissolved in a 7:3 mixture of water and diethylamine in order to obtain a 15% by weight (based on the metal oxide content) ATO precursor solution. 200 g of the above-described ATO precursor solution were dissolved with 200 g of 15% PVP solution in ethanol, and then 50 ml of ethanol were added. The resulting solution had the following characteristics:

Viscosity (23.5° C.): 0.22 Pa×s

Conductivity (23.5° C.): 383 μS/cm

The electrospinning of this solution was performed using the Nanospider unit (NS Lab 500S, from Elmarco, Czech Republic). Electrode type: 6-wire electrode; electrode separation 25 cm; voltage: 82 kV.

The resulting fibers (also known as green fibers) were calcined under an air atmosphere. To this end, they were heated to 550° C. at a heating rate of 5° C. per minute and this temperature of 550° C. was maintained for two hours in order to obtain the ATO nanofibers in the form of light blue solid.

The mean diameter of the fibers was in the range from 100 to 130 nm.

Aspect ratio (length/diameter): >>100:1

Specific conductivity: 0.9 S/cm, measured by the four-point method on a pressed tablet, consisting of ATO fibers and 3% by weight of PVDF (binder)

### EXAMPLE 2

### Synthesis of ATO (Antimony Tin Oxide) Nanofibers

The sol-gel precursor solution comprising 6.7% by weight of PVP (Kollidon 92F from BASF SE), 6.7% by weight of ATO precursor, 26.4% by weight of water, 48.9% by weight of ethanol and 11.3% by weight of diethylamine was prepared as follows:

While stirring vigorously, a solution of 66 g of tin(IV) chloride and 5.8 g of antimony(III) chloride and 2.24 g of ε-caprolactam in 560 g of water was prepared. The solution was heated up to 50° C. and, at this temperature, 142 g of a 25% by weight aqueous ammonium hydroxide solution were added. The resulting suspension was stirred at 50° C. for 10 hours. The precipitate formed was removed by means of a centrifuge and washed four times with water with a pH of 10 (set with ammonia solution), being redispersed with an Ultraturrax each time. The precipitate obtained was dissolved in a 7:3 mixture of water and diethylamine in order to obtain a 15% by weight (based on the metal oxide content) ATO precursor solution. 200 g of the above-described ATO precursor solution were dissolved with 200 g of 15% PVP solution in ethanol, and then 50 ml of ethanol were added. The resulting solution had the following characteristics:

Viscosity (23.5° C.): 0.22 Pa×s

Conductivity (23.5° C.): 383 μS/cm

The electrospinning was performed using the Nanospider unit (NS Lab 500S, from Elmarco, Czech Republic). Electrode type: 6-wire electrode; electrode separation 25 cm; voltage: 82 kV.

The resulting fibers (also known as green fibers) were calcined under an air atmosphere. To this end, they were heated to 550° C. at a heating rate of 5° C. per minute and this temperature of 550° C. was maintained for two hours in order to obtain the ATO nanofibers in the form of light blue solid.

### EXAMPLE 3

### Synthesis of ATO (Antimony Tin Oxide) Nanofibers

The sol-gel precursor solution comprising 6.7% by weight of PVP (Kollidon 92F from BASF SE), 6.7% by weight of ATO precursor, 26.4% by weight of water, 48.9% by weight of ethanol and 11.3% by weight of diethylamine was prepared as follows:

200 g of a 25% by weight aqueous ammonium hydroxide solution comprising 16.9 g of DL-alanine were introduced into a glass flask. While stirring vigorously, a solution of 78.4 g of tin(IV) chloride and 5.2 g of antimony(III) chloride in 960 g of ethanol and 16 g of concentrated HCl was added. The suspension formed was then heated to 150° C. in an autoclave for 3.5 hours. After cooling, the precipitate was removed by means of a centrifuge and washed four times with water, being redispersed each time with an Ultraturrax. The precipitate obtained was dissolved in a 7:3 mixture of water and diethylamine in order to obtain a 15% by weight (based on the metal oxide content) ATO precursor solution. 200 g of the above-described ATO precursor solution were dissolved with 200 g of 15% PVP solution in ethanol, and then 50 ml of ethanol were added.

The electrospinning was performed using a Nanospider unit (NS Lab 500S, from Elmarco, Czech Republic). Electrode type: 6-wire electrode; electrode separation 25 cm; voltage: 82 kV.

The resulting fibers (also known as green fibers) were calcined under an air atmosphere. To this end, they were heated to 550° C. at a heating rate of 5° C. per minute and this temperature of 550° C. was maintained for two hours in order to obtain the ATO nanofibers in the form of light blue solid.

### EXAMPLE 4

### Synthesis of ATO (Antimony Tin Oxide) Nanofibers

The sol-gel precursor solution comprising 6.7% by weight of PVP (Kollidon 92F from BASF SE), 6.7% by weight of ATO precursor, 26.4% by weight of water, 48.9% by weight of ethanol and 11.3% by weight of diethylamine was prepared as follows:

While stirring vigorously, a solution of 66 g of tin(IV) chloride and 5.8 g of antimony(III) chloride and 2.24 g of ε-caprolactam in 560 g of water was prepared. The solution was heated up to 50° C. and, at this temperature, 142 g of a 25% by weight aqueous ammonium hydroxide solution were added. The resulting suspension was stirred at 50° C. for 10 hours. The suspension formed was then introduced into an autoclave and heated to 150° C. for 3.5 hours. After cooling, the precipitate was removed by means of a centrifuge and washed four times with water, being redispersed each time with an Ultraturrax. The precipitate obtained was dissolved in a 7:3 mixture of water and diethylamine in order to obtain a 15% by weight (based on the metal oxide content) ATO precursor solution. 200 g of the above-described ATO precursor solution were dissolved with 200 g of 15% PVP solution in ethanol, and then 50 ml of ethanol were added.

The electrospinning was performed using the Nanospider unit (NS Lab 500S, from Elmarco, Czech Republic). Electrode type: 6-wire electrode; electrode separation 25 cm; voltage: 82 kV.

The resulting fibers (also known as green fibers) were calcined under an air atmosphere. To this end, they were heated to 550° C. at a heating rate of 5° C. per minute and this temperature of 550° C. was maintained for two hours.

### EXAMPLE 5

### Synthesis of ATO (Antimony Tin Oxide) Nanofibers

A sol-gel precursor solution comprising 4.8% by weight of PVP (Sigma-Aldrich, MW 1 300 000), 11.5% by weight of ATO precursor, 25.7% by weight of water, 10% by weight of ethanol, 35.2% by weight of methanol and 12.8% by weight of diethylamine was prepared as follows:

200 g of a 25% by weight aqueous ammonium hydroxide solution were introduced into a glass flask. While stirring vigorously, a solution of 78.4 g of tin(IV) chloride and 5.2 g of antimony(III) chloride in 960 g of ethanol and 16 g of concentrated HCl was added. The precipitate formed was removed by means of a centrifuge and washed four times with water with a pH of 10 (set with ammonia solution), being redispersed with an Ultraturrax each time. The precipitate obtained was dissolved in a 2:1 mixture of water and diethylamine in order to obtain a 23% by weight (based on the metal oxide content) ATO precursor solution. 200 g of the above-described ATO precursor solution were dissolved with 160 g of 12% PVP solution in methanol, and then 40 g of ethanol were added.

The electrospinning of this solution was spun to nanofibers with an electrospinning unit (“needle electrospinning”, i.e. a syringe pump in combination with a high-voltage unit). The advance rate of the syringe pump was set to 0.5 ml/h; the electrode separation was 8 cm at a voltage of 7 kV.

The resulting fibers (also known as green fibers) were calcined under an air atmosphere. To this end, they were heated to 550° C. at a heating rate of 5° C. per minute and this temperature of 550° C. was maintained for two hours in order to obtain the ATO nanofibers in the form of light blue solid.

1.-15. (canceled)

16. A process for producing metal oxide fibers with a diameter in the range from 0.1 to 999, comprising the steps of:
(a) providing a solution of one or more metal compounds in at least one solvent selected from the group of water, ethanol, methanol, i-propanol, n-propanol, tetrahydrofuran and dimethylformamide,
(b) alkaline precipitation of the at least one metal of the at least one metal compound in the form of the hydroxide thereof from the solution provided in (a) in order to obtain a suspension,
(c) removing the at least one hydroxide precipitated in process step (b),
(d) redispersing the at least one hydroxide removed in process step (c) in an amine or solvent-amine mixture,
(e) preparing a solution comprising one or more polymer(s), one or more solvents, and the mixture prepared in process step (d),
(f) electrospinning the solution prepared in process step (e) and
(g) removing the polymer.

17. The process according to claim 16, wherein the metal compound is a metal compound of a metal selected from the group of Cu, Ag, Au, Ti, Zr, Hf, V, Nb, Ta, Cr, Mo, W, Mn, Re, Fe, Ru, Ni, Pd, Co, Rh, Ir, Sb, Sn, In, Al, Ga, Er and Zn.

18. The process according to claim 16, wherein the alkaline precipitation in process step (b) is performed at a pH in the range from 8 to 12.

19. The process according to claim 16, wherein the alkaline precipitation in process step (b) is effected by adding at least one ammonium compound and/or at least one alkali metal hydroxide.

20. The process according to claim 16, wherein the alkaline precipitation in process step (b) is preceded by adding to the solution at least one stabilizer selected from the group of alanine, phenylalanine, valine, leucine and ε-caprolactam.

21. The process according to claim 16, wherein the suspension obtained in process step (b), before the performance of process step (c), is heated to a temperature in the range from 60 to 200° C.

22. The process according to claim 16, wherein the removal of the metal hydroxide in process step (c) is followed by washing of the hydroxide.

23. The process according to claim 16, wherein the solvent-amine mixture in process step (d) comprises at least one solvent selected from the group of water, methanol, ethanol, i-propanol, n-propanol, tetrahydrofuran (THF) and dimethylformamide and dimethylformamide, and at least one amine which is at least one amine from the group of primary, secondary or tertiary amine of the general formula NR₃ where R is independently H, a substituted or unsubstituted, straight-chain or branched alkyl group having 1 to 6 carbon atoms.

24. The process according to claim 16, wherein the polymer in process step (e) is selected from the group of polyethers, polyethylene oxides, polyvinyl alcohols, polyvinyl alcohol-polyvinyl acetate copolymers, polyvinyl acetates, polyvinylpyrrolidones, polyacrylic acids, polyurethanes, polylactides, polyglycosides, polyvinylformamides, polyvinylamines, polyvinylimines and polyacrylonitriles, or is a mixture of two or more of the aforementioned polymers.

25. The process according to claim 16, wherein the at least one solvent in process step (e) is selected from the group of water, methanol, ethanol, ethandiol, n-propanol, 2-propanol, n-butanol, isobutanol, tert-butanol, cyclohexanol, formic acid, acetic acid, trifluoroacetic acid, diethylamine, diisopropylamine, phenylethylamine, acetone, acetylacetone, acetonitrile, diethylene glycol, formamide, dimethylformamide (DMF), dimethyl sulfoxide (DMSO), toluene, dimethylacetamide, N-methylpyrrolidone and tetrahydrofuran, or is a mixture of two or more.

26. The process according to claim 16, wherein the polymer in process step (g) is removed thermally, chemically, radiatively, biologically, physically, with plasma or ultrasound, or by extraction with a solvent.

27. The process according to claim 16, wherein the removal of the polymer in process step (g) is followed by a reduction of the metal oxide fibers to the corresponding metal fibers.

28. The process according to claim 16, wherein crystalline and/or amorphous metal oxide nanoparticles and/or metal nanoparticles are added to the solution which is prepared in process step (e).
